(19) United States
(12) Patent Application Publication
(10) Pub. No.: US 2018/0058247 A1
(43) Pub. Date: Mar. 1, 2018

(54) VANE ACTUATOR AND METHOD OF MAKING AND USING THE SAME

(71) Applicant: BorgWarner Inc., Auburn Hills, MI (US)

(72) Inventors: Aliihsan Karamavruc, Fletcher, NC (US); Roland Roth, Arden, NC (US); Clement Kiefer, Basse-Ham (FR)

(21) Appl. No.: 15/244,469

(22) Filed: Aug. 23, 2016

(51) Int. Cl. F01D 17/16; F01D 9/04; F01D 25/24

(52) U.S. Cl. CPC F01D 17/165; F05D 2220/40; F01D 25/24; F01D 9/041

(57) ABSTRACT

A number of variations may include a product comprising: a turbine comprising a lower ring, a upper ring, a plurality of vanes, wherein each of the vanes comprises a vane post mechanically coupling the lower ring and the upper ring to the vane, and a vane actuator comprising an actuator ring constructed and arranged to operate the vanes uniformly based on movement of the actuator ring.

### TECHNICAL FIELD

The field to which the disclosure generally relates to includes vane actuators.

### BACKGROUND

In a number of variations, a turbocharger may include a turbine comprising a plurality of vanes.

### SUMMARY OF ILLUSTRATIVE VARIATIONS

A number of variations may include a product comprising: a turbine comprising a lower ring, a upper ring, a plurality of vanes, wherein each of the vanes comprises a vane post mechanically coupling the lower ring and the upper ring to the vane, and a vane actuator comprising an actuator ring constructed and arranged to operate the vanes uniformly based on movement of the actuator ring.

A number of variations may include a method comprising: providing a turbine comprising a lower ring, a upper ring, a plurality of vanes, wherein each of the vanes comprises a vane post mechanically coupling the lower ring and the upper ring to the vane, and a vane actuator comprising an actuator ring constructed and arranged to operate the vanes uniformly based on movement of the actuator ring; and actuating the vanes into an open position or a closed position uniformly through movement of the actuator ring.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a sectional perspective view of a product according to a number of variations.

FIG. 2A illustrates a sectional perspective view of a product according to a number of variations.

FIG. 2B illustrates a sectional perspective view of a product according to a number of variations.

FIG. 2C illustrates a radial perspective cross-sectional view of a product according to a number of variations.

FIG. 2D illustrates a sectional perspective view of a product according to a number of variations.

FIG. 3A illustrates an axial cross-sectional view of a product according to a number of variations.

FIG. 3B illustrates a sectional perspective view of a product according to a number of variations.

FIG. 3C illustrates a sectional perspective view of a product according to a number of variations.

FIG. 4A illustrates a sectional perspective view of a product according to a number of variations.

FIG. 4B illustrates an axial cross-sectional view of a product according to a number of variations.

FIG. 4C illustrates an axial cross-sectional view of a product according to a number of variations.

FIG. 4D illustrates a radial cross-sectional view of a product according to a number of variations.

FIG. 4E illustrates a sectional perspective view of a product according to a number of variations.

FIG. 4F illustrates a sectional perspective view of a product according to a number of variations.

### DETAILED DESCRIPTION OF ILLUSTRATIVE VARIATIONS

The following description of the variations is merely illustrative in nature and is in no way intended to limit the scope of the invention, its application, or uses.

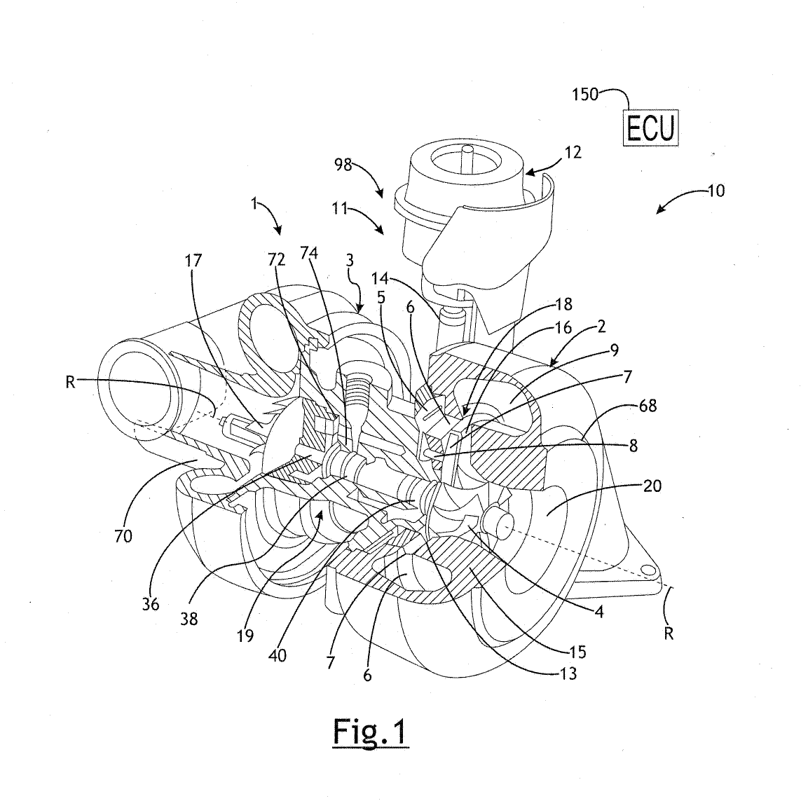

Referring to FIG. 1, in a number of variations, a product 10 is shown. In a number of variations, the product 10 may include a turbomachinery device 10. In a number of variations, the turbomachinery device may be a device that includes a high speed machine that includes a rotor and a fluid and transfers energy from a fluid to a rotor or vice versa. In a number of variations, the turbomachinery device 10 may include at least one of a turbocharger, an electrified turbocharger, a compressor, a turbine, an expansion device, an organic rankine cycle (ORC) device, a motor used in turbomachinery, a booster, an electrified booster, an electrified turbo compound component, or may be another device. In a number of non-limiting variations, as shown in FIG. 1, the product 10 may include a turbocharger 1. In a number of variations, the product 10 or turbocharger 1 may include at least one of a turbine 68 and/or at least one compressor 70, a variation of which is illustrated in FIG. 1. In a number of variations, the product 10 or turbocharger 1 or turbine 68 may comprise a turbine wheel or rotor 4. In a number of variations, the turbocharger 4 or turbine 68 may have variable turbine geometry (VTG). In a number of variations, the product 10 or turbocharger 1 or compressor 70 may comprise a compressor wheel or rotor 17. In a number of variations, the turbine wheel or rotor 4 may be operatively connected to a compressor wheel or rotor 17 through a shaft 36. In a number of variations, the turbine wheel 4 may receive thermodynamic power from exhaust gas from the system and may drive the shaft 36 which may then drive the compressor wheel 17. In a number of variations, the shaft 36 may be supported for rotation by at least one bearing 38, 40. In a number of variations, the product 10 or turbocharger 1 may include a first bearing 38 and a second bearing 40. In a number of variations, the product 10 or turbocharger 1 may include a turbine housing 2 and a compressor housing 3 which may be connected to it via a bearing housing 19. In a number of variations, the product 10 may include a bearing lubrication system 72. In a number of variations, a fluid 74 may be provided to the first and second bearings 38, 40 through the bearing lubrication system 72 in order to ensure proper rotation of the shaft 36. In a number of variations, the fluid 74 may include oil, coolant, or may be another type.

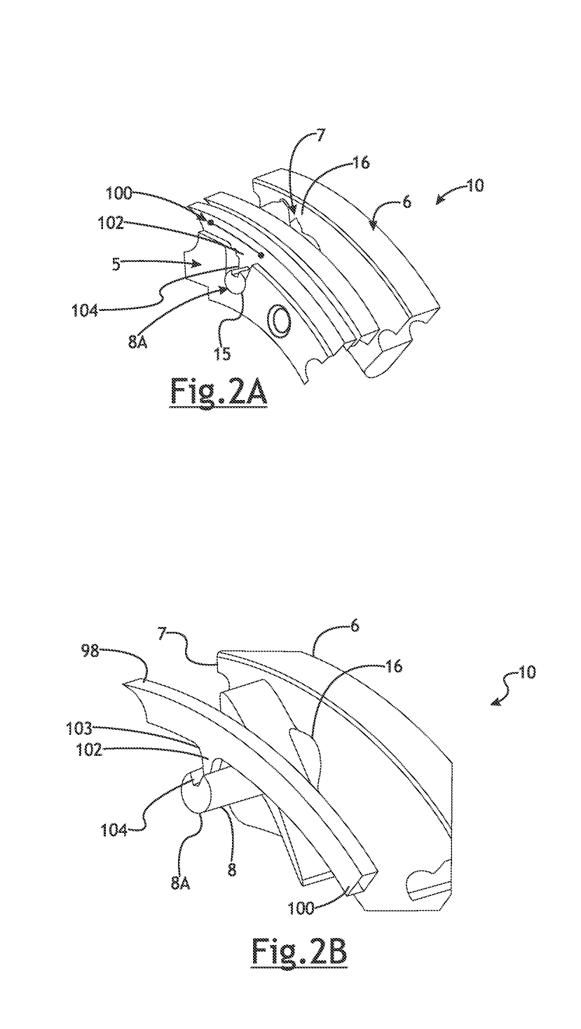

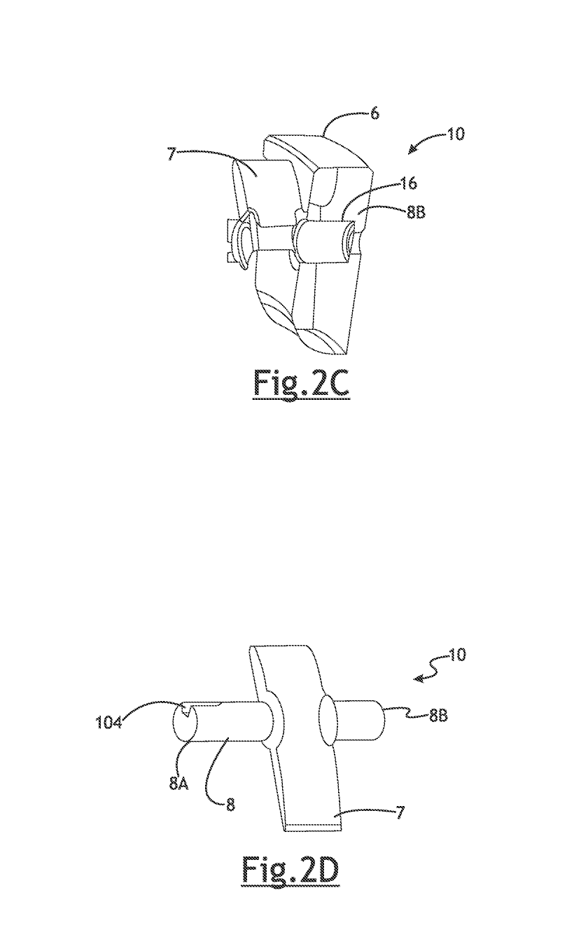

Still referring to FIG. 1, in a number of variations, the housings 2, 3 and 19 may be arranged along a rotational axis R. In the non-limiting example shown in FIG. 1, the turbine housing 2 is shown partially in section in order to illustrate the arrangement of a lower ring 6 as part of a radially outer vane cascade 18 which may have a plurality of vanes 7, with pivots or vane posts 8, which may be distributed over the circumference. In a number of variations, a vane 7 may include an individual vane post 8 which may actuate the vane 7 into an “open” or “closed” position. In a number of variations, as shown in FIG. 2D, the vane post 8 may have a first end 8A and a second end 8B. As a result of this, in a number of variations, nozzle cross sections may be formed which, depending upon the position of the vanes 7, may be larger or smaller and may expose the turbine rotor 4, which may be mounted in the middle on the rotational axis R, to a greater or lesser extent to the action of the exhaust gas of an engine. In a number of variations, an “open” position may be defined as allowing gas through the vane cascade 18 via an opening created by actuation of the vane 7. In a number of variations, a “closed” position may be defined as allowing no gas through the vane cascade 18 via an opening created by actuation of the vane 7. In a number of variations, the exhaust gas of an engine may be fed via a feed passage 9 and may be discharged via a central duct 10 in order to drive a compressor rotor 17, which may be seated upon the same shaft 36, via the turbine rotor 4.

In a number of variations, in order to control the movement or the position of the vanes 7, the product 10 or turbocharger 1 may include an operating device 11 which may include a vane actuator 98. In a number of variations, the operating device 11 may include and ECU 150 which may operate the movement or position of the vanes 7 based on conditions within the product 10 or its surroundings or applications of the product 10. In a number of variations, the operating device 11 may include a control housing 12 which may control movement of a ram component 14 which may be fastened to it, in order to convert its movement onto a vane upper ring 5, which may be located behind the vane lower ring 6. In a number of variations, the vane cascade 18 or vanes 7 may be located between the upper ring 5 and the lower ring 6. In a number of variations, the vane cascade 18 or at least one vane 7 may be mechanically coupled to at least one of the upper ring 5 or the lower ring 6. In a number of variations, the vane cascade 18 or at least one vane 7 may be mechanically coupled to the upper ring 5 and the lower ring 6. In a number of variations, the vane cascade 18 or at least one vane 7 may be mechanically coupled to at least one of the upper ring 5 or the lower ring 6 through the vane post 8. In a number of variations, the vane cascade 18 or at least one vane 7 may be mechanically coupled to the upper ring 5 and the lower ring 6 through the vane post 8. In a number of variations, the vane cascade 18 or at least one vane 7 may be mechanically coupled to the upper ring 5 and the lower ring 6 through the vane post 8 where the vane post first end 8A mechanically couples the upper ring 5 and the vane post second end 8B mechanically couples the lower ring 6. In a number of variations, the vane actuator 98 may include an actuator ring 100. In a number of variations, the vane actuator 98 may move or rotate the actuator ring 100. In a number of variations, the vane actuator 98 may include a plurality of actuator rings 100. In a number of variations, the vane actuator 98 may include the vane cascade 18 and plurality of vanes 7. In a number of variations, the actuator ring 100 may be between the vane cascade 18 and the upper ring 5. In a number of variations, the actuator ring 100 may be between the vane cascade 18 and the lower ring 6. In a number of variations, the actuator ring 100 may be on the outside of the upper ring 5. In a number of variations, the actuator ring 100 may be on the outside of the lower ring 6. In a number of variations, the vane cascade 18 or at least one vane 7 may be mechanically coupled the actuator ring 100 through the vane post 8 on the first end 8A, second end 8B or at another point. In a number of variations, the control housing 12 may control the movement of a ram component 14 which may be fastened to it, in order to convert its movement onto the actuator ring 100 and subsequently into an actuation of the vane cascade 19 or at least one vane 7 to an “open” or “closed” position, based on free movement of the actuator ring 100. In a number of variations, a free space 13 for the vanes 7 may be formed between the vane bearing ring 6 and an annular section 25 of the turbine housing 2. In order to be able to safeguard this free space 13, the lower ring 6 may have spacers 16 which may be formed in one piece. In a non-limiting exemplary case, three spacers 26 may be arranged on the circumference of the vane bearing ring 6 with an angular spacing of 120° in each case. In principle, however, it may be possible to provide such spacers 26 in a greater or lesser number.

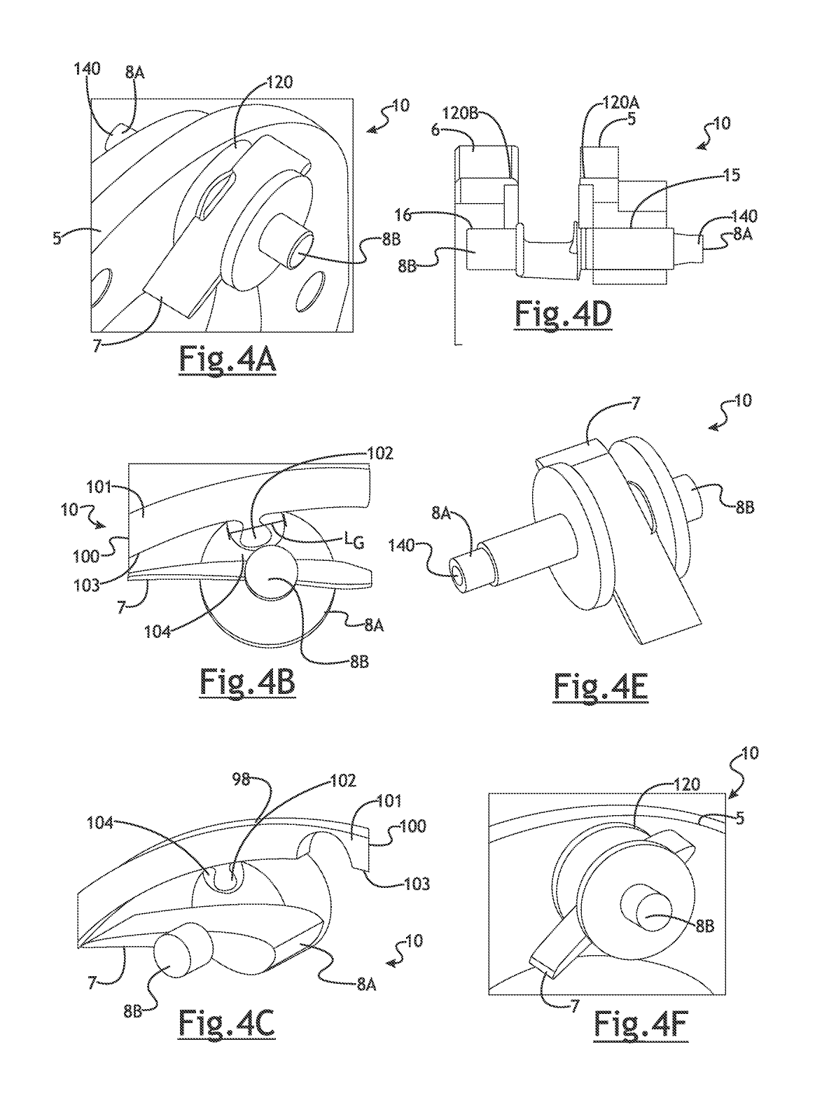

In a number of variations, as shown in FIGS. 2A-2D, the vane may be between the lower ring 6 and the upper ring 5. In a number of variations, as shown in FIG. 2A, the actuator ring 100 may be between at least one vane 7 and the upper ring 5. In a number of variations, as shown in FIG. 2D, the vane post 8 may have a first end 8A and a second end 8B. As illustrated in FIGS. 2A and 2C, in a number of variations, the vane post first end 8A may mechanically couple to the upper ring 5 and the lower post 8B may mechanically couple to the lower ring 6. In a number of variations, as shown in FIGS. 2A, 3A, 4A, 4D, and 4F, the upper ring 5 may include an upper ring bore 15. In a number of variations, as shown in FIGS. 2A, 3A, 4A, 4D, and 4F, the first end 8A of the vane post 8 may fit into and mechanically couple to the upper ring bore 15 of the upper ring 5. In a number of variations, as shown in FIGS. 2A, 2B, 2C, 3B, 3C, 4D, the lower ring 6 may include a lower ring bore 16. In a number of variations, as shown in FIGS. 2A, 2B, 3B, 3C, and 4D, the second end 8B of the vane post 8 may fit into and mechanically couple to the lower ring bore 16 of the lower ring 6. In a number of variations, as shown in FIGS. 2A-2D, the vane post 8 may include at least one groove 104. In a number of variations, the vane post 8 may include a groove 104 along a longitudinal side of the first end 8A. In a number of variations, the vane post 8 may include a groove 104 along a longitudinal side of the second end 8B. In a number of variations, the actuator ring 100 may include at least one spline 102. In a number of variations, as shown in FIG. 2A, 2B, 4B, and 4C, the actuator ring 8 may include at least one spline 102 along a radial edge 103 of the actuator ring 8. In a number of variations, as shown in FIGS. 2A-2B, the spline 102 of the actuator ring 100 may mechanically couple to the groove 104 of the vane post 8. In a number of variations, this may mechanically couple the actuator ring 100 to the vane 7. In a number of variations, movement or rotation of the actuator ring 100 may move or rotate the at least one spline 102 which may in turn move or rotate the groove 104 of the vane post 8 which may move or rotate the vane 7 from an “open” position to a “closed” position and vice versa. In a number of variations, the actuator ring 100 may include a plurality of splines 102 mechanically coupled to a plurality of grooves 104 on individual vane posts 8 such that the actuator ring 100 may be mechanically coupled to a plurality of vanes 7. In a number of variations, each of the grooves 104 in the vane posts 8 may be mechanically coupled to at least one spline 102 of the actuator ring 100. In a number of variations, the actuator ring 100 may be constructed and arranged to operate a plurality of vanes uniformly based on movement of the actuator ring 100. In a number of variations, the movement of the actuator ring 100 that actuates the vanes 7 may be rotational in a clockwise or counterclockwise direction where one direction “opens” the vanes and the other direction “closes” the vanes. In a number of variations, as shown in FIG. 4B-4C, the spline 102 may be in the shape of a dogbone. In a number of variations, the groove 104 may have a wider length L_{G} to accommodate the dogbone shape. In a number of variations, a dogbone shape may reduce friction and stress between the vanes 7 and the actuator ring 100 during operation.

In a number of variations, as illustrated in FIG. 4A, 4D, 4E, and 4F, the vane 7 may include a buffer region 120 between the vane post 8 and the vane 7. In a number of variations, as shown in FIG. 4A, 4D, and 4F, the buffer region 120 may abut an axial surface of the upper ring 5 up to the vane post first end 8A as it accepted in the upper ring bore 15. In a number of variations, as shown in FIG. 4A, the buffer region 120A may be accepted at least partially into the upper ring bore 15. In a number of variations, as shown in FIG. 4D, the buffer region 120A may abut an axial surface of the lower ring 6 up to the vane post second end 8B as it accepted in the lower ring bore 16. In a number of variations, as shown in FIG. 4D, the buffer region 120B may be accepted at least partially into the lower ring bore 16. In a number of variations, as shown in FIG. 4D, the vane 7 may have dual buffer regions 120A, 120B, which may be accepted at least partially into the upper ring bore 15 and lower ring bore 16 respectively. In a number of variations, as shown in FIG. 4A, 4D, and 4E, the vane post first end 8A may project out through the upper ring bore 15. In a number of variations, as shown in FIG. 4E, the vane post first end 8A may include a vane post bore 140. In a number of variations, the actuator ring 100 may include at least one axial face spline (not shown) projecting outward from an axial surface 101 of the actuator ring 100. In a number of variations, the axial face spline of the actuator ring 100 may mechanically couple to the vane post bore 140 of the vane post 8. In a number of variations, this may mechanically couple the actuator ring 100 to the vane 7. In a number of variations, movement or rotation of the actuator ring 100 may move or rotate the at least one axial face spline which may in turn move or rotate the vane post bore 140 of the vane post 8 which may move or rotate the vane 7 from an “open” position to a “closed” position and vice versa. In a number of variations, the actuator ring 100 may include a plurality of axial face splines mechanically coupled to a plurality of vane post bores 140 on individual vane posts 8 such that the actuator ring 100 may be mechanically coupled to a plurality of vanes 7. In a number of variations, the axial face spline may include a key. In a number of variations, the vane post bore 140 may include a grooved interior to accept the key on the axial face spline. In a number of variations, the axial face spline may include a groove.

In a number of variations, the vane post bore 140 may include an interior key to accept the groove on the axial face spline. In a number of variations, each of the vane post bores 140 in the vane posts 8 may be mechanically coupled to at least one radial face spline of the actuator ring 100. In a number of variations, the actuator ring 100 may be constructed and arranged to operate a plurality of vanes uniformly based on movement of the actuator ring 100. In a number of variations, the movement of the actuator ring 100 that actuates the vanes 7 may be rotational in a clockwise or counterclockwise direction where one direction “opens” the vanes and the other direction “closes” the vanes.

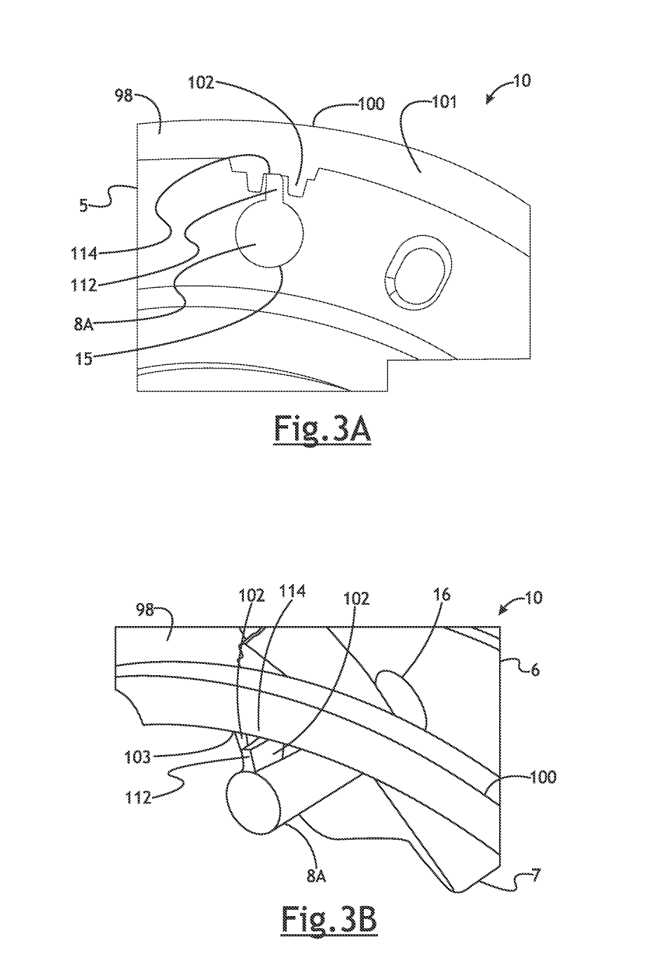

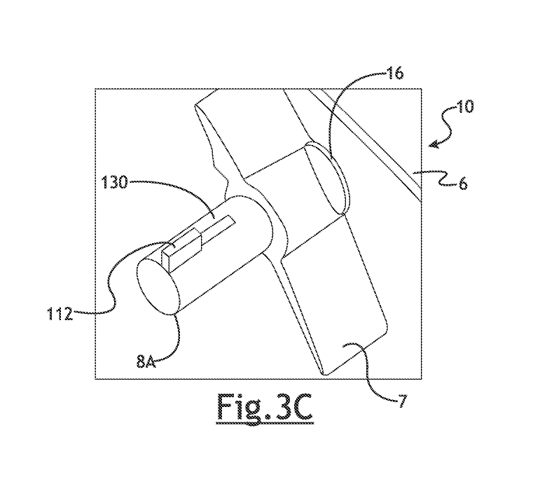

In a number of variations, as shown in FIGS. 3A-3C, the actuator ring 100 may include a groove 114 that may be formed between a plurality of actuator splines 102. In a number of variations, the vane post 8 may include a spline 112 along a longitudinal side of the first end 8A. In a number of variations, the vane post 8 may include a spline 112 along a longitudinal side of the second end 8B. In a number of variations, the vane post 8 may include a spline 112 that may mechanically couple to at least one of the grooves 114 formed in the actuator ring 100. In a number of variations, this may mechanically couple the actuator ring 100 to the vane 7. In a number of variations, movement or rotation of the actuator ring 100 may move or rotate the at least one groove 114 which may in turn move or rotate the spline 112 of the vane post 8 which may move or rotate the vane 7 from an “open” position to a “closed” position and vice versa. In a number of variations, the actuator ring 100 may include a plurality of grooves 114 mechanically coupled to a plurality of splines 112 on individual vane posts 8 such that the actuator ring 100 may be mechanically coupled to a plurality of vanes 7. In a number of variations, each of the splines 112 in the vane posts 8 may be mechanically coupled to at least one groove 114 of the actuator ring 100. In a number of variations, the actuator ring 100 may be constructed and arranged to operate a plurality of vanes uniformly based on movement of the actuator ring 100. In a number of variations, the movement of the actuator ring 100 that actuates the vanes 7 may be rotational. In a number of variations, as shown in FIG. 3C, the first end 8A of the vane post 8 may be an insert which locks into the vane 7 through a key mechanism 130.

It is also noted that any mechanical coupling of the actuator ring 100 and the vane post 8 may be undertaken without departing from the scope of the invention including a vane actuator 98 involving a nut, bolt, fastener, buckle, button, cable tie, clamp, clip, clutch, flange, frog, grommet, latch, nail, peg, pin, hook and loop fastener, rivet, screw anchor, snap fastener, staple, stitch, strap, threaded fastener, tie, toggle bolt, zipper, wedge anchor or may be another type. In a number of variations, the product 10 including any of its components (including the vane actuator 98, vane 7, vane post 8, actuator ring 100, upper ring 5, lower ring 6, or may be another component) may be made of aluminum, cast iron, molded plastic, carbon fiber, other die cast metal, or other suitable material. In a number of variations, the components of the product 10 (including the vane actuator 98, vane 7, vane post 8, actuator ring 100, upper ring 5, lower ring 6, or may be another component) may be secured in the orientations illustrated by staking, casting it in position, machining, assembly, or other suitable means.

In a number of variations, a method 800 is shown. In a number of variations, the method 800 may include in block 802 providing a turbine comprising a lower ring, a upper ring, a plurality of vanes, wherein each of the vanes comprises a vane post mechanically coupling the lower ring and the upper ring to the vane, and a vane actuator comprising an actuator ring constructed and arranged to operate the vanes uniformly based on movement of the actuator ring. In a number of variations, the method 800 may further include, in block 804, actuating the vanes into an open position or a closed position uniformly through movement of the actuator ring.

In a number of variations, product 10 or vane actuator 98 may actuator all of the vanes 8 of the vane cascade 18 uniformly, eliminating the need for individual vane levers for each vane, which may reduce cost of manufacture, assembly, and componentry, as well as reduce complexity of the product 10 or actuation of the vane cascade 18. In a number of variations, the product 10 or vane actuator 98 may lessen or eliminate vane sticking, vane non-actuation, or non-uniform vane cascade 18 actuation in undesirable conditions such as high or non-uniform temperature environments.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising: a turbine comprising a lower ring, a upper ring, a plurality of vanes, wherein each of the vanes comprises a vane post mechanically coupling the lower ring and the upper ring to the vane, and a vane actuator comprising an actuator ring constructed and arranged to operate the vanes uniformly based on movement of the actuator ring.

Variation 2 may include a product as set forth in Variation 1 wherein the actuator ring comprises a plurality of splines.

Variation 3 may include a product as set forth in Variation 2 wherein each of the vane posts comprises a groove that mechanically couples with at least one spline of the actuator ring.

Variation 4 may include a product as set forth in any of Variations 1-3 wherein the actuator ring comprises a plurality of grooves.

Variation 5 may include a product as set forth in Variation 4 wherein each of the vane posts comprises a spline that mechanically couples with at least one groove of the actuator ring.

Variation 6 may include a product as set forth in any of Variations 2-5 wherein at least one of the splines has a dogbone shape.

Variation 7 may include a product as set forth in any of Variations 1-6 wherein at least one of the lower ring or the upper ring comprises a bore that mechanically couples to the vane through the vane post.

Variation 8 may include a product as set forth in any of Variations 2-7 wherein the vane post comprises a bore that mechanically couples with at least one spline of the actuator ring.

Variation 9 may include a product as set forth in any of Variations 1-8 wherein product comprises a turbocharger.

Variation 10 may include a product as set forth in any of Variations 1-9 wherein turbine has variable turbine geometry.

Variation 11 may include a method comprising: providing a turbine comprising a lower ring, a upper ring, a plurality of vanes, wherein each of the vanes comprises a vane post mechanically coupling the lower ring and the upper ring to the vane, and a vane actuator comprising an actuator ring constructed and arranged to operate the vanes uniformly based on movement of the actuator ring; and actuating the vanes into an open position or a closed position uniformly through movement of the actuator ring.

Variation 12 may include a method as set forth in Variation 11 wherein the actuator ring comprises a plurality of splines.

Variation 13 may include a method as set forth in Variation 12 wherein each of the vane posts comprises a groove that mechanically couples with at least one spline of the actuator ring.

Variation 14 may include a method as set forth in any of Variations 11-13 wherein the actuator ring comprises a plurality of grooves.

Variation 15 may include a method as set forth in Variation 14 wherein each of the vane posts comprises a spline that mechanically couples with at least one groove of the actuator ring.

Variation 16 may include a method as set forth in any of Variations 12-15 wherein at least one of the splines has a dogbone shape.

Variation 17 may include a method as set forth in any of Variations 11-16 wherein at least one of the lower ring or the upper ring comprises a bore that mechanically couples to the vane through the vane post.

Variation 18 may include a method as set forth in any of Variations 12-17 wherein the vane post comprises a bore that mechanically couples with at least one spline of the actuator ring.

Variation 19 may include a method as set forth in any of Variations 11-18 wherein product comprises a turbocharger.

Variation 20 may include a method as set forth in any of Variations 11-19 wherein turbine has variable turbine geometry.

The above description of select variations within the scope of the invention is merely illustrative in nature and, thus, variations or variants thereof are not to be regarded as a departure from the spirit and scope of the invention.

What is claimed is:

1. A product comprising:
a turbine comprising a lower ring, an upper ring, a plurality of vanes, wherein each of the vanes comprises a vane post mechanically coupling the lower ring and the upper ring to the vane, and a vane actuator comprising an actuator ring constructed and arranged to operate the vanes uniformly based on movement of the actuator ring;
wherein the actuator ring comprises a plurality of splines radially extending from the actuator ring, and wherein each of the vane posts comprises a groove that mechanically couples with at least one spline of the actuator ring.

2. The product of claim 1 wherein the actuator ring comprises a plurality of splines.

3. The product of claim 2 wherein each of the vane posts comprises a groove that mechanically couples with at least one spline of the actuator ring.

4. The product of claim 1 wherein the actuator ring comprises a plurality of grooves.

5. The product of claim 4 wherein each of the vane posts comprises a spline that mechanically couples with at least one groove of the actuator ring.

6. The product of claim 1 wherein at least one of the splines has a dogbone shape.

7. The product of claim 1 wherein at least one of the lower ring or the upper ring comprises a bore that mechanically couples to the vane through the vane post.

8. The product of claim 1 wherein the vane post comprises a bore that mechanically couples with at least one spline of the actuator ring.

9. The product of claim 1 wherein product comprises a turbocharger.

10. The product of claim 9 wherein turbine has variable turbine geometry.

11. A method comprising:
providing a turbine comprising a lower ring, upper ring, a plurality of vanes, wherein each of the vanes comprises a vane post mechanically coupling the lower ring and the upper ring to the vane, and a vane actuator comprising an actuator ring constructed and arranged to operate the vanes uniformly based on movement of the actuator ring;
wherein the actuator ring comprises a plurality of splines radially extending from the actuator ring, and wherein each of the vane posts comprises a groove that mechanically couples with at least one spline of the actuator ring; and
actuating the vanes into an open position or a closed position uniformly through movement of the actuator ring.

12. The method of claim 11 wherein the actuator ring comprises a plurality of splines.

13. The method of claim 12 wherein each of the vane posts comprises a groove that mechanically couples with at least one spline of the actuator ring.

14. The method of claim 11 wherein the actuator ring comprises a plurality of grooves.

15. The method of claim 14 wherein each of the vane posts comprises a spline that mechanically couples with at least one groove of the actuator ring.

16. The method of claim 11 wherein at least one of the splines has a dogbone shape.

17. The method of claim 11 wherein at least one of the lower ring or the upper ring comprises a bore that mechanically couples to the vane through the vane post.

18. The method of claim 11 wherein the vane post comprises a bore that mechanically couples with at least one spline of the actuator ring.

19. The method of claim 11 wherein product comprises a turbocharger.

20. The method of claim 19 wherein turbine has variable turbine geometry.
